(19) United States
(12) Patent Application Publication
(10) Pub. No.: US 2023/0298351 A1
(43) Pub. Date: Sep. 21, 2023

(54) LIVE INVENTORY AND INTERNAL ENVIRONMENTAL SENSING METHOD AND SYSTEM FOR AN OBJECT STORAGE STRUCTURE

(71) Applicant: Springhouse Technologies Inc., McLean, VA (US)

(72) Inventors: Jaeyoon (Jay) Lee, McLean, VA (US); John Anderson, Brooklyn, NY (US); Tyler Cameron Sanborn, Long Island City, NY (US); Boris Kontorovich, Brooklyn, NY (US); Charles Carter Parks, Laramie, WY (US); Jenny O'Neil, Golden, CO (US); Bryce Copenhaver, Brooklyn, NY (US); Robert Marsh, Ponte Vedra Beach, FL (US); Travis Ruddy, Dayton, OH (US)

(21) Appl. No.: 18/109,384

(22) Filed: Feb. 14, 2023

Related U.S. Application Data
(60) Provisional application No. 63/309,785, filed on Feb. 14, 2022.

(51) Int. Cl. G06V 20/50; G06Q 10/087; G06T 7/20; G06V 10/774; H04N 7/18; G06V 40/10

(52) U.S. Cl. CPC G06V 20/50; G06Q 10/087; G06T 7/20; G06V 10/774; H04N 7/188; G06V 40/11; G06T 2207/20081; G06T 2207/10016; G06T 2207/10028; G06T 2207/10024; G06T 2207/30196

(57) ABSTRACT

A Live Inventory System and Process for use with an active object storage structure, such as a refrigerator. The disclosed System and Process includes a method for dynamically identifying an object being placed in or taken out of a refrigerator, the method comprising: detecting a motion of an object at the refrigerator using one or more sensors coupled with the refrigerator or sensing a refrigerator open condition; acquiring one or more images of at least a part of the object as the object is being placed inside the refrigerator or removed from the refrigerator; and using the acquired images, tracking the motion of the object, determining a direction of the motion of the object, and identifying the object using a trained ML (Machine Learning) model, the ML model trained, at least in part, using a crowd-based training method including acquisition of images from other refrigerators.

### CROSS REFERENCE TO RELATED APPLICATION

This application claims priority to U.S. Provisional Patent Application Ser. No. 63/309,785, filed Feb. 14, 2022, the entirety of which is fully incorporated herein by reference.

### BACKGROUND

The present exemplary embodiment relates to object detection, tracking and identification, as well as the incorporation of gas sensing technologies into a storage compartment, such as but limited to, a refrigerator, cooling unit, cabinet, storage container, etc. It finds particular application in conjunction with a refrigerator and will be described with particular reference thereto. However, it is to be appreciated that the present exemplary embodiment is also amenable to other like applications.

### INCORPORATION BY REFERENCE

U.S. Pat. No. 9,784,497, granted, Oct. 19, 2017;
U.S. Ser. No. 10/956,856, granted Mar. 23, 2021;
U.S Published Patent Application US20160088262, published Mar. 24, 2016;
U.S Published Patent Application 20170219276, published Aug. 3, 2017;
U.S Published Patent Application US20190311319, published Oct. 10, 2019;
U.S Published Patent Application US20190354926, published Nov. 21, 2019; and
U.S Published Patent Application US20200088463, published Mar. 19, 2020, the entireties of which are fully incorporated herein by reference.

### BRIEF DESCRIPTION

According to one embodiment of this disclosure, disclosed is a method for dynamically identifying an object being placed in or taken out of a refrigerator, the method comprising: detecting a motion of an object at the refrigerator using one or more sensors coupled with the refrigerator or sensing the refrigerator is open; acquiring one or more images of at least a part of the object as the object is being placed inside the refrigerator or removed from the refrigerator; and using the acquired images, tracking the motion of the object, determining a direction of the motion of the object, and identifying the object using a trained ML (Machine Learning) model, the ML model trained, at least in part, using a crowd-based training method including acquisition of images from other refrigerators.

According to another embodiment of this disclosure, disclosed is a computer readable storage medium including executable computer code embodied in a tangible form wherein the computer readable medium comprises: executable computer code operable to detect a motion of an object being placed in or taken out of a refrigerator using one or more sensors coupled with the refrigerator or sensing the refrigerator is open; executable computer code operable to acquire one or more images of at least a part of the object; executable computer code operable to determine a direction of the motion of the object; and executable computer code operable to identify the object based on the one or more images, wherein the computer code uses the acquired images to track the motion of the object, determine a direction of the motion of the object, and identify the object using a trained ML (Machine Learning) model, the ML model trained, at least in part, using a crowd-based training method including acquisition of images from other refrigerators.

According to another embodiment of this disclosure, disclosed is a storage system comprising: a refrigerator; one or more sensors coupled with the refrigerator; at least one processor coupled with the refrigerator; one or more cameras operatively associated with the storage system; and at least one memory circuitry coupled with the refrigerator, the at least one memory circuitry including a computer readable storage medium that includes computer code stored in a tangible form wherein the computer code, when executed by the at least one processor, causes the storage system to: detect a motion of an object being placed in or taken out of the refrigerator using the one or more sensors or sensing the refrigerator is open; acquire one or more images of at least a part of the object; and determine a direction of the motion of the object; and using the acquired images, track the motion of the object, determine a direction of the motion of the object, and identify the object using a trained ML (Machine Learning) model, the ML model trained, at least in part, using a crowd-based training method including acquisition of images from other refrigerators.

### BRIEF DESCRIPTION OF THE DRAWINGS

FIG. 1 is a system diagram of a cloud-based Refrigerator Live Inventory System according to an embodiment of this disclosure, the Refrigerator Live Inventory System including: Refrigerator #1 11A, Refrigerator #2-n 11B, Administration 12, Cloud 13, Smart Phone/Mobile Device 1 14A, Smart Phone/Mobile Device 2 14B, Smart Phone/Mobile Device n 14C and Springhouse Database 36.

FIGS. 2A, 2B and 2C include an overall processes flow chart of a Refrigerator Live Inventory System according to an embodiment of this disclosure, the Refrigerator Live Inventory System process including the following processes/subprocesses: Script starts from CL (Command Line Interface) 21, Application Initialization 22, Hardware Initialization 23, Are sensors triggered? 24, Begin Acquisition 25, Data Lake URL set based on environment 26, Folder created for images 27, Camera acquisition, saving raw images 28, Sensors untriggered? 29, API Call to Database 30, Raw to JPEG image Conversion 31, Process Uploads to Data Lake (or image Upload to Cloud) 32, Barcodes to be predicted queue 33, Barcode Detection Function (or Model for barcode) 34, zBar Open Source Barcode Reader 35, Springhouse Database 36, Images to be predicted queue 37, Image Prediction Function 38, Inference Endpoint for Object Detection 39, Trained Object Prediction Model 40, Object detection model training 41, Image Creation Function 42, Match Image to Sequence 43, Is Last Prediction in sequence? 44, Get Image Predictions and Barcode Detections 45, Direction Function 46, Inference Endpoint for Direction 47, Trained Direction Model 48, Direction model training 49, Annotation QA Service (or Image QA service) 50, Create Inventory Changes 51, Front-end Application 52, Inventory Change confirmed by Springhouse admin 53, and Image Annotation Service 54.

FIG. 3 is another overall process flow chart of a Refrigerator Live Inventory System according to an embodiment of this disclosure, the Refrigerator Live Inventory System including, in part, a local refrigerator 11A, a cloud base Image Processing application associated with one or more Image Creation Functions 42, a function to Match an Image to a Sequence 43 and accessing a Springhouse Database 36; a Trained Object Prediction Model 40, an Image Annotation Service 54, an Image Annotation QA Service 50, a Front-end Application 52, a Barcode Detection Function/Model for barcode 34, and a Trained Direction Model 48.

FIGS. 4A, 4B and 4C are illustrations of a Refrigerator according to an embodiment of this disclosure, these figures illustrating Lighting Strips (both sides of opening and above each shelf) 60, Entry Plane Sensors (both sides of opening, going from top to bottom) 61, Cameras (both sides per shelf) 62 and Proximity Sensors (above each shelf) 63.

FIG. 5 is a high-level thread processes flow chart of a Refrigerator Live Inventory System according to an embodiment of this disclosure, the Refrigerator Live Inventory System including an Initial System process to set variables, create threads, prepare environments 100, a Camera Trigger Thread to check sensors and update variables 200, an Image Acquisition Thread when triggered, captures images and send them to other threads 300, a Data Processing Thread to process raw images and upload compressed photos 400, an Image Deletion Thread to delete all images in a sequence where object did not enter shelf 500, a Processed Photo Directory Deletion Thread to wait a specified amount of time, then delete the processed photo directory 600.

FIGS. 6A-6G include detailed processes flow charts of a Refrigerator Live Inventory System as shown in FIG. 5 according to an embodiment of this disclosure, the figures providing further process details executed by the System Initialization process 100 (FIG. 6B), the Image Acquisition Thread 300 FIG. (FIG. 6C); the Camera Trigger Thread 200 (FIG. 6D); the Data Processing Thread 400 (FIG. 6E); the Image Deletion Thread 500 (FIG. 6F), and the Processed Photo Directory Deletion Thread 600 (FIG. 6G).

FIG. 7 is an overall processes flow chart of cloud-based image processing operations performed for a Refrigerator Live Inventory System according to an embodiment of this disclosure, the cloud-based image processing operations including a Refrigerator notifying the API that image upload is complete 701, a process for Image Creation-Image gets created in the database 702, communication with a Springhouse API/Database 800, a process for Object Tracking/Identification 900, a a process for Barcode Detection 1000, and a process for ML Model Training 1100.

FIGS. 8A-8F are more detailed flow charts of is the cloud-based image processing operations, shown in FIG. 7, performed for a Refrigerator Live Inventory System according to an embodiment of this disclosure, the figures providing further process details for a Refrigerator notifying the API that image upload is complete 701 (FIG. 8A), a process for Image Creation-Image gets created in the database 702 (FIG. 8A), communication with a Springhouse API/Database 800 (FIG. 8A), a process for Object Tracking/Identification 900 (FIG. 8C), a process for Barcode Detection 1000 (FIG. 8F), and a process for ML Model Training 1100 (FIG. 8D). In addition, a Synthetic Data process 1200 to synthetically generate images for Object Detection/Prediction Training is shown.

### DETAILED DESCRIPTION

Refrigerators have becoming increasingly sophisticated and provide an array of features. One area, however, which has seen relatively limited progress, is inventory management. That is, a user of a refrigerator typically uses the appliance to store fruits, vegetables, beverages, leftovers, and a variety of other foods. However, it is all too easy to forget what items are in the refrigerator, when they were put there and when certain items will expire or should be replaced.

In one aspect, a method for detecting a moving object being placed in a refrigerator and providing a live inventory of the refrigerator contents based on the detected objects placed in the refrigerator or removed from the refrigerator will be described. One or more images are acquired of at least a part of the object. A direction of the motion of the object is tracked. An object is identified based on the one or more images. In various embodiments, an inventory for the storage structure, i.e., refrigerator, is updated based on the object motion tracking and the object identity.

Other features include, but are not limited to, Image Recognition, Digital Inventory, Item Tagging and Expiration Tracking, Temperature Zones, Adaptive Exterior feature, Camera Integration, Drawers, Modular Shelving, UI Integration, Computer Vision, Scanning, Voice, Crowdsourcing, Sensing, and Lighting features.

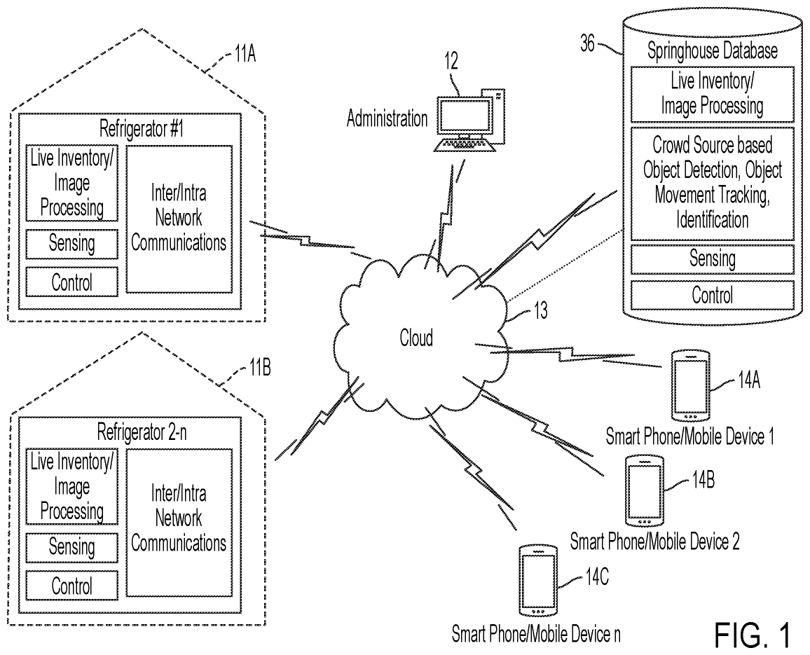

With reference to FIG. 1, shown is a system diagram of a cloud-based Refrigerator Live Inventory System according to an embodiment of this disclosure, the Refrigerator Live Inventory System including; Refrigerator #1 11A, Refrigerator #2-n 11B, Administration 12, Cloud 13, Smart Phone/Mobile Device 1 14A, Smart Phone/Mobile Device 2 14B, Smart Phone/Mobile Device n 14C and Springhouse Database 36.

As shown, the Live Inventory System and Process includes a system/method for dynamically identifying an object being placed in or taken out of a refrigerator 11A, the method comprising: detecting a motion of an object at the refrigerator using one or more sensors coupled with the refrigerator 13/36 or sensing the refrigerator is open; acquiring one or more images of at least a part of the object as the object is being placed inside the refrigerator or removed from the refrigerator 13/36; and using the acquired images, tracking the motion of the object, determining a direction of the motion of the object, and identifying the object using a trained ML (Machine Learning) model 13/36, the ML model trained, at least in part, using a crowd-based training method including acquisition of images from other refrigerators.

FIG. 1 is a high-level view of how the entire Springhouse platform functions. Each refrigerator has its own user and inventory tracked by the Springhouse Database and then brought to life through the Springhouse digital application. Additionally, each refrigerator has its own live inventory identification model that is a subset of the global model. This local model provides to be more accurate based on previous purchases by the user set. Once an inventory Is created within a specific user, the digital application uses said inventory to assist the user with recipe creation, food replenishment, food spoilage, guidance, and statistics for food waste.

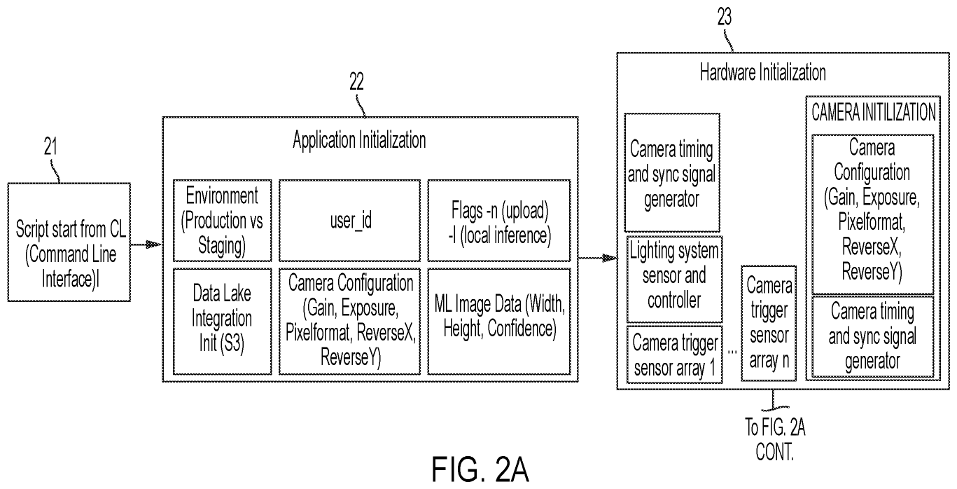

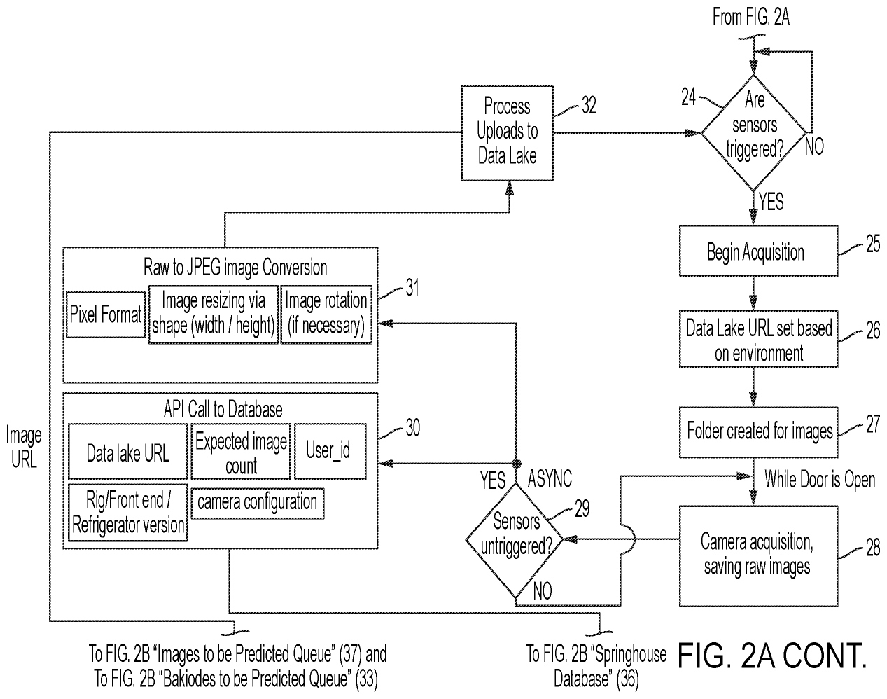

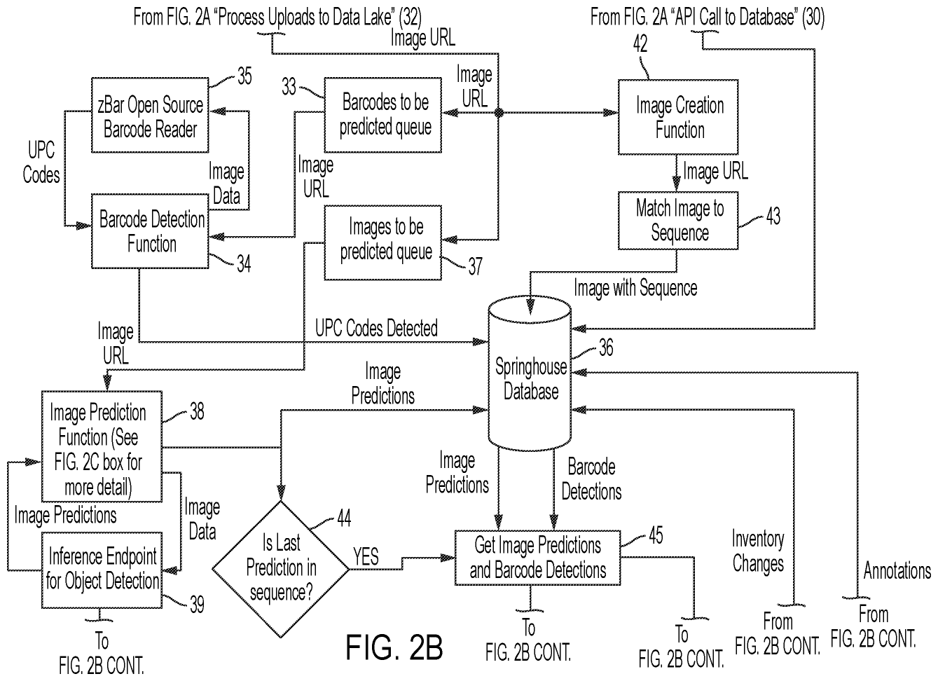

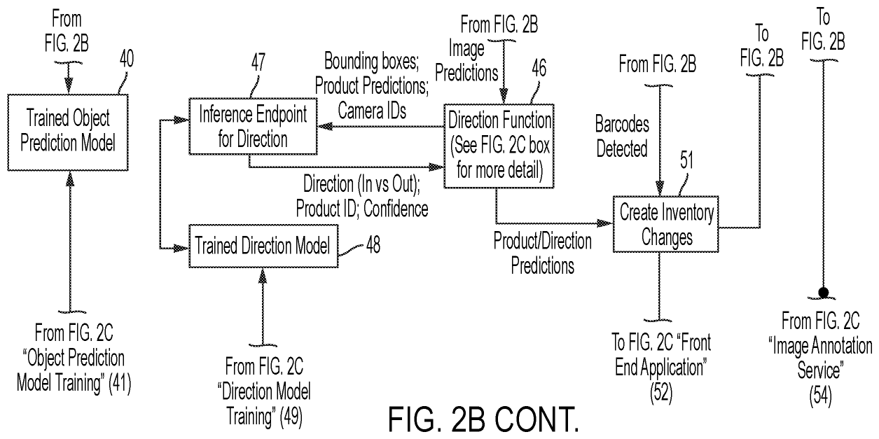

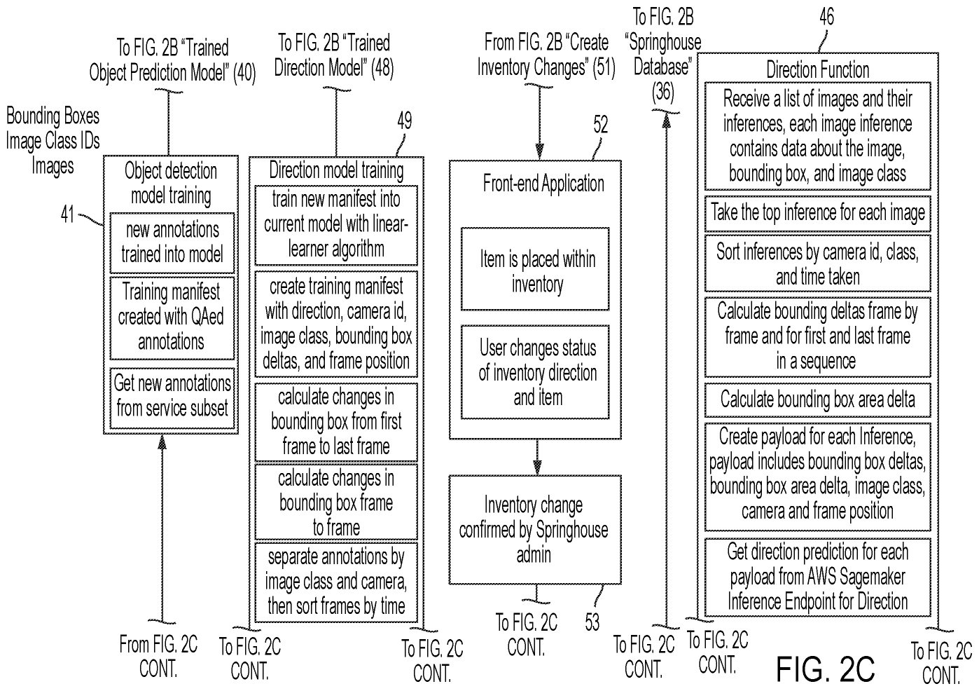

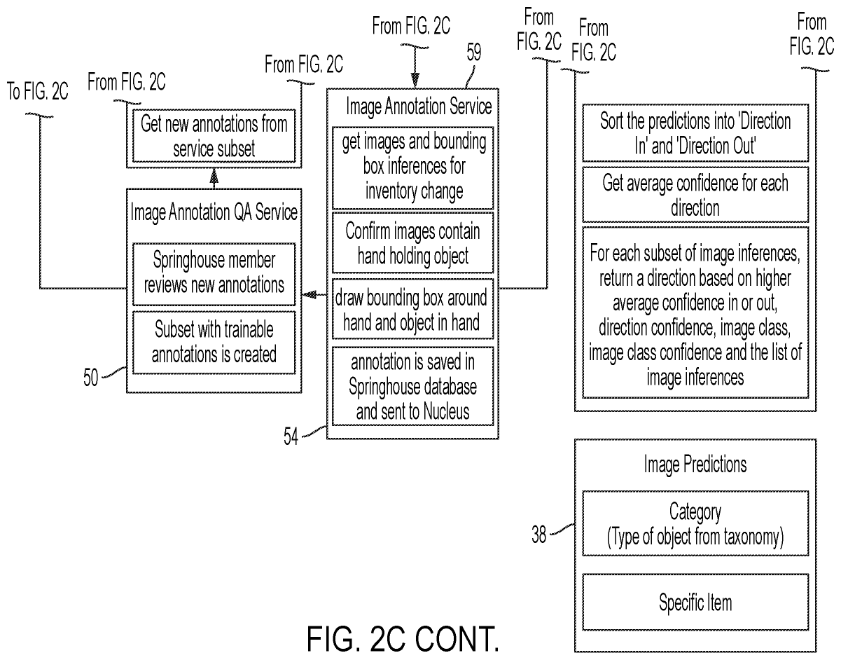

With reference to FIGS. 2A, 2B and 2C, shown is an overall processes flow chart of a Refrigerator Live Inventory System according to an embodiment of this disclosure, the Refrigerator Live Inventory System process including the following processes/subprocesses:

Initially, a Script starts from CL (Command Line Interface) 21;

Then, Application Initialization 22 is performed, including Environment (Production vs Staging); user id; Flags -n (upload), -l (local inference); Data Lake Integration Init (S3); Camera Configuration (Gain, Exposure, Pixelfromat, ReverseX, ReverseY), ML Image Data (Width, Height, Confidence);

Then, Hardware Initialization 23, Camera timing and sync signal generator; Lighting system sensor and controller; Camera trigger sensor array 1-n; Camera Initialization including Camera Configuration (Gain, Exposure, Pixelfromat, ReverseX, ReverseY) and Camera timing and sync signal generator;

Then the process determines if the sensors are triggered 24, indicating the refrigerator has been opened, and if they are the process Begins Acquisition 25 AND the Process Uploads to Data Lake (or image Upload to Cloud) 32;

After Acquisition has begun 25, the process performs the following in sequence:
Data Lake URL set based on environment 26;
Folder created for images 27;
Camera acquisition, saving raw images 28;
Sensors untriggered? 29, If NO, RETURN to Camera acquisition 28, if YES, then the process performs an API Call to Database 30 AND performs a Raw to JPEG image Conversion 31;
The API Call to Database 30 provides data including the following: Data lake URL; Rig/Front end/Refrigerator version; Expected image count; camera configuration; and user_id. Then, after execution of the API Call, the process simultaneously creates a Barcodes to be predicted queue 33, Images to be predicted queue 37, and initializes an Image Creation Function 42 process.

Further processing of the images in the Barcodes to be predicted queue 33, includes a Barcode Detection Function (or Model for barcode) 34, and a zBar Open Source Barcode Reader 35, to read barcodes present in the processed images. The barcode results are stored in the Springhouse Database 36.

Further processing of the images in the Images to be predicted queue 37 includes an Image Prediction Function 38 process, an Inference Endpoint for Object Detection 39 process, and a Trained Object Prediction Model 40 process. An Object detection model training 41 process provides supervised and/or unsupervised training of the Object Prediction Model, including: new annotations trained into model; Training manifest created with QAed annotations; and Getting new annotations from a service subset.

The Image Prediction Function 38 process outputs image data including a category of the object predicted, i.e., a type of object from a taxonomy, and data indicating a specific item associated with the image object. This data is stored in the Springhouse Database 36. In addition, a Last Prediction in sequence determination 44 is made by the process, and IF it is determined the last prediction in the sequence has been processed, the process advances to Get Image Predictions and Barcode Detections 45 from the Springhouse Database 36.

After the Image Predictions and Barcode Detections 45 are retrieved from the Springhouse Database 36, the process performs a Direction Function 46 process including: an Inference Endpoint for Direction 47 process which uses a Trained Direction Model 48. The Trained Direction Model 48 including the following subprocesses: train new manifest into current model with linear learner algorithm; create training manifest with direction, camera id, image class, bounding box deltas, and frame position; calculate changes in bounding box from first frame to lasts frame; calculate changes in bounding box frame to frame; separate annotations by image class and camera, then sort frames by time; Get new annotations from service subset.

An Image Annotation QA Service 50 provides annotated training data to the Direction Model Training process 49 including: Springhouse member reviews of new annotations; and creation of a Subset with trainable annotations.

Further processing of the images input to the Image Creation Function 42 includes Matching an Image to a Sequence 43, and then storing the matched image in the Springhouse Database 36.

Based on the results of the execution of the Get Image Predictions and Barcode Detections 45 process, and the Direction Function 46, the process advances to Create Inventory Changes 51, based on the following: A Front-end Application 52 including: Item is placed within inventory; and/or User changes status of inventory direction and item. Inventory Change confirmed by Springhouse admin 53, and an Image Annotation Service 54 including: get images and bounding box inferences for inventory change; confirm images contain hand holding object; and draw bounding box around hand and object in hand. (According to one exemplary embodiment, annotation is saved in Springhouse database and sent to Nucleus to be used for training the Object Prediction Model 41 and training the Direction Model 49. However, other manners of training are within the scope of this disclosure)

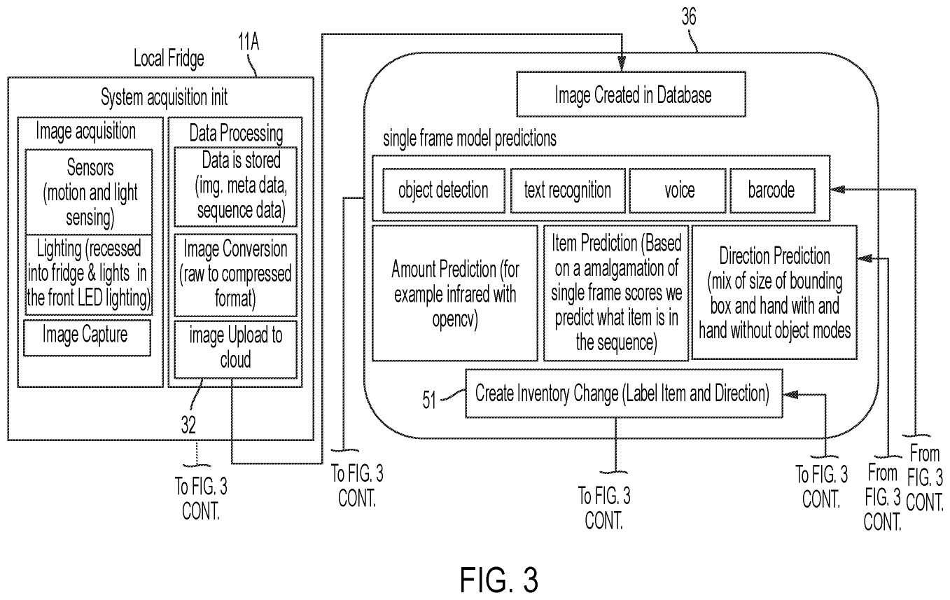

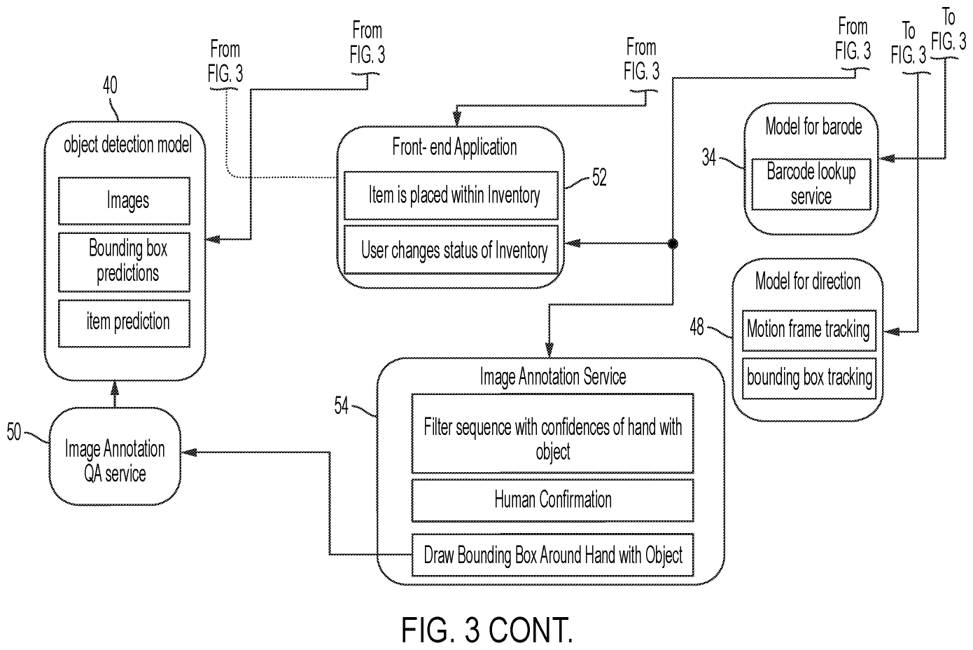

With reference to FIG. 3, shown is another overall process flow chart of a Refrigerator Live Inventory System according to an embodiment of this disclosure, the Refrigerator Live Inventory System including, in part, a local refrigerator 11A, a cloud base Image Processing application associated with one or more Image Creation Functions 42, a function to Match an Image to a Sequence 43 and accessing a Springhouse Database 36; a Trained Object Prediction Model 40, an Image Annotation Service 54, an Image Annotation QA Service 50, a Front-end Application 52, a Barcode Detection Function/Model for barcode 34, and a Trained Direction Model 48.

The local refrigerator 11A, including processes related to Image acquisition including: Sensors(motion and light sensing); Lighting (recessed into refrigerator & lights in the front LED lighting) Image Capture; Data Processing including: Data is stored (img, meta data, sequence data); Image Conversion (raw to compressed format); and image Upload to cloud.

A cloud base Live Inventory Image Processing application 36 including: Image Created in Database process; single frame model predictions including object detection, text recognition; voice; and barcode processes; Amount Prediction process (for example: infrared with OpenCV); Item Prediction process (Based on an amalgamation of single frame scores, we predict what item is in the sequence); Direction Prediction process (mix of size of bounding box and hand with and hand without object modes; and Create Inventory Change process (Label Item and Direction).

A Trained Object Prediction Model 40 process including processes related to Images; Bounding box predictions; and item prediction.

An Image Annotation Service 54, and an Image Annotation QA Service 50, the Image Annotation QA Service 50 including: Springhouse member reviews of new annotations; and creation of Subset with trainable annotations.

A Front-end Application 52 including: inventory change processes related to an Item placed within inventory; and User changes status of inventory direction and item.

A Barcode Detection Function/Model for barcode identification 34, and a Trained Direction Model 48.

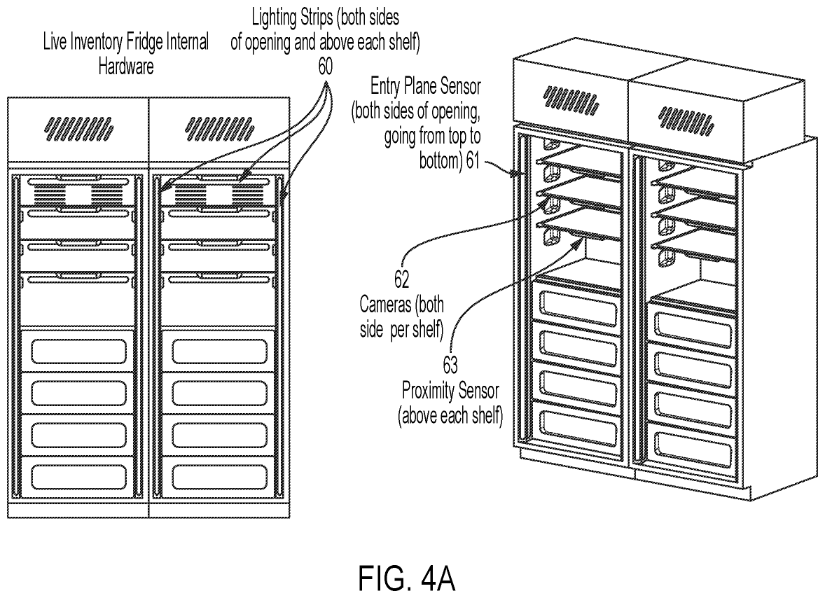

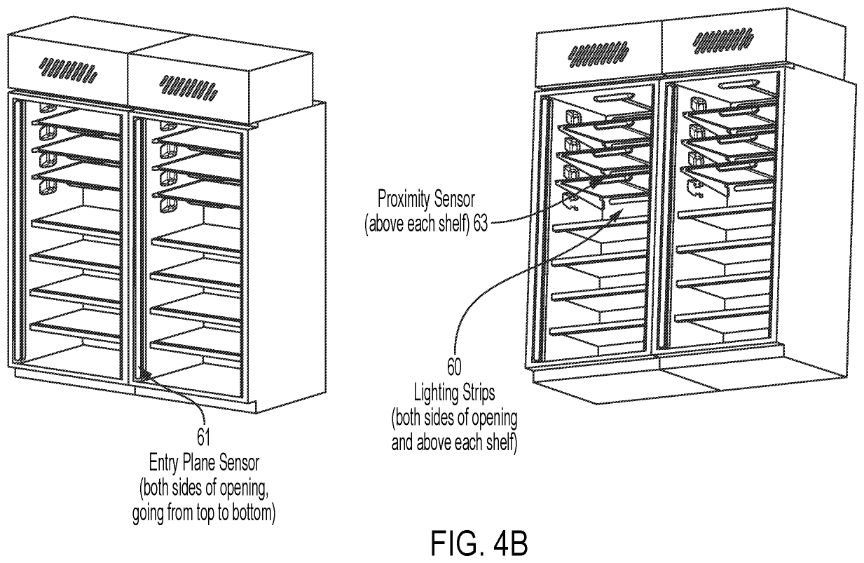

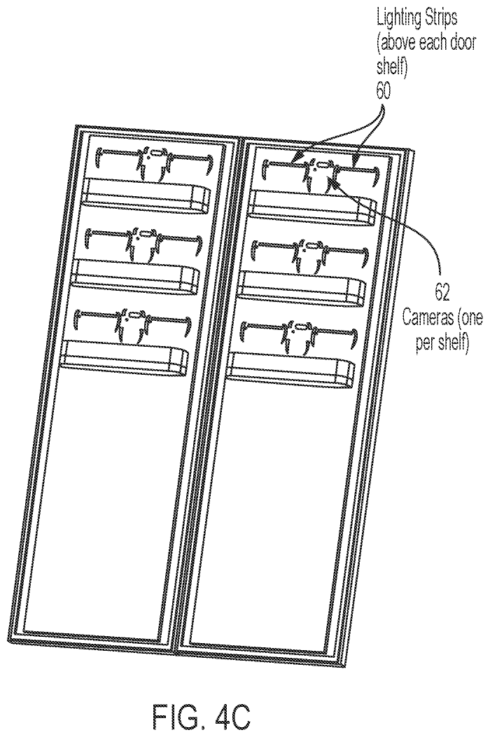

With reference to FIGS. 4A, 4B and 4C, shown is a Refrigerator according to an embodiment of this disclosure, these figures illustrating Lighting Strips (both sides of opening and above each shelf) 60, Entry Plane Sensors (both sides of opening, going from top to bottom) 61, Cameras (both sides per shelf) 62 and Proximity Sensors (above each shelf) 63.

According to an exemplary embodiment of this disclosure the Lighting Strips (both sides of opening and above each shelf) 60, the luminance and location of these lights are optimized for accurate raw image acquisition from the cameras (both sides per shelf) 62. The Entry Plane Sensors 61 and Proximity Sensors 63 provide sensing to determine when to begin the image acquisition process, i.e., begin acquiring images as a hand/object is placed in the refrigerator or removed from the refrigerator.

According to an exemplary embodiment of this disclosure, there are two model sets (that are made up of smaller models) to predict two elements within live inventory: tracking items and identifying items. Tracking is run on the local hardware. As a user moves towards the refrigerator, the depth cameras trigger the rgb cameras to begin capturing. In parallel of capture, another thread is open for processing. If an “item in hand” is identified within the sequence, the tracking model will sort the sequence to determine if the object passed a certain plane. If so, the model then determines if the item went in or out of the refrigerator. If true, the local computer sends the relative images to the cloud where another model set is run to identify the item. Once identified, a change in the user database and inventory has been made based on the above information.

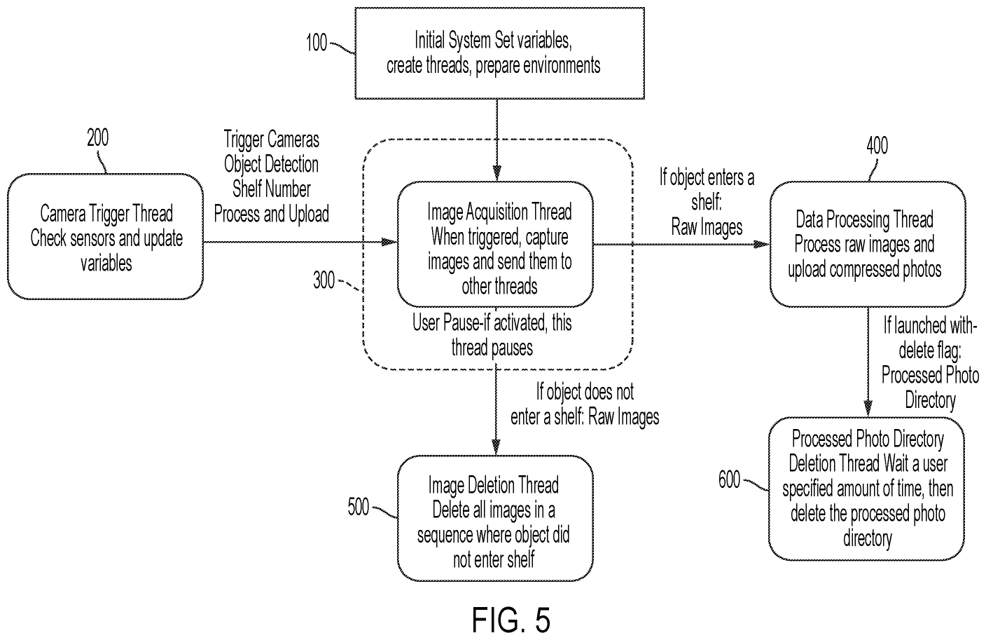

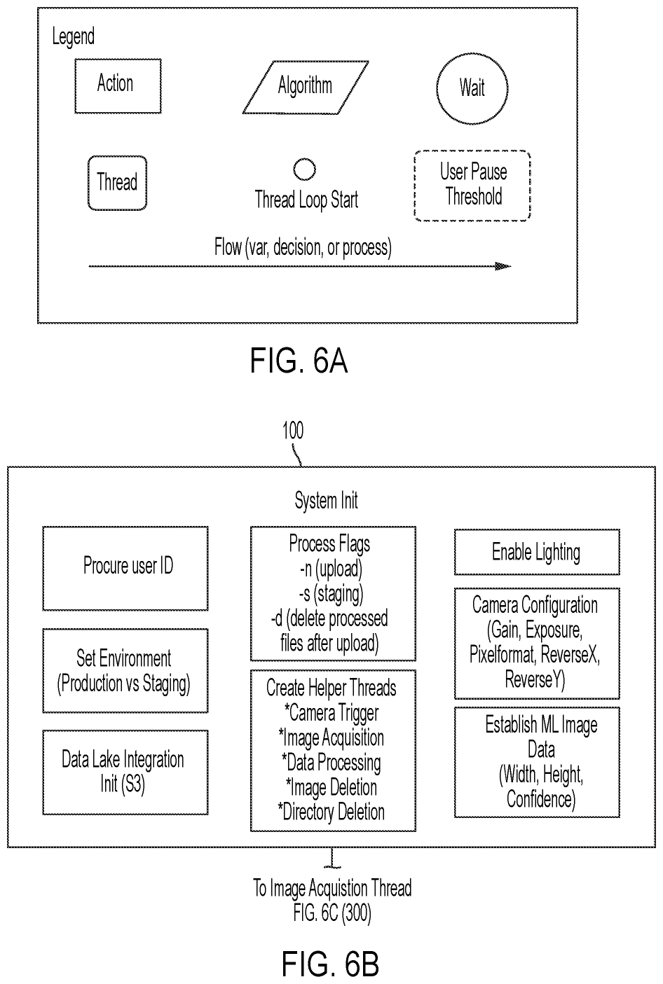

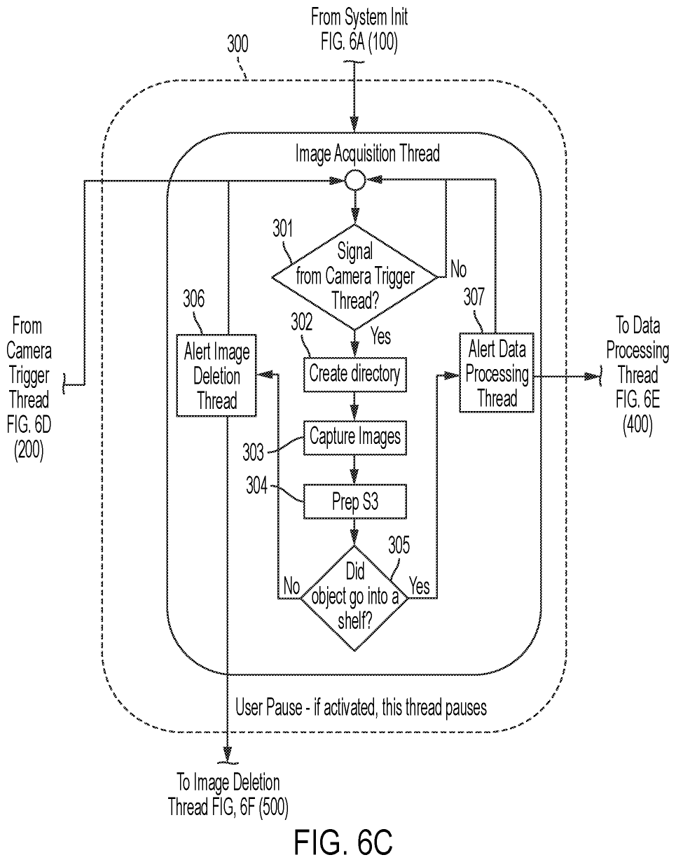

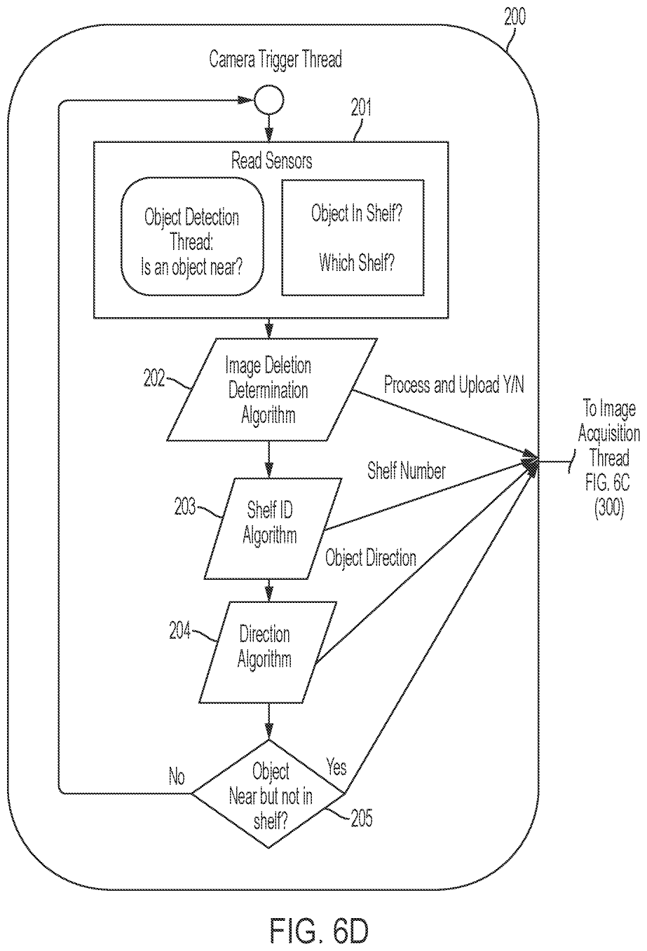

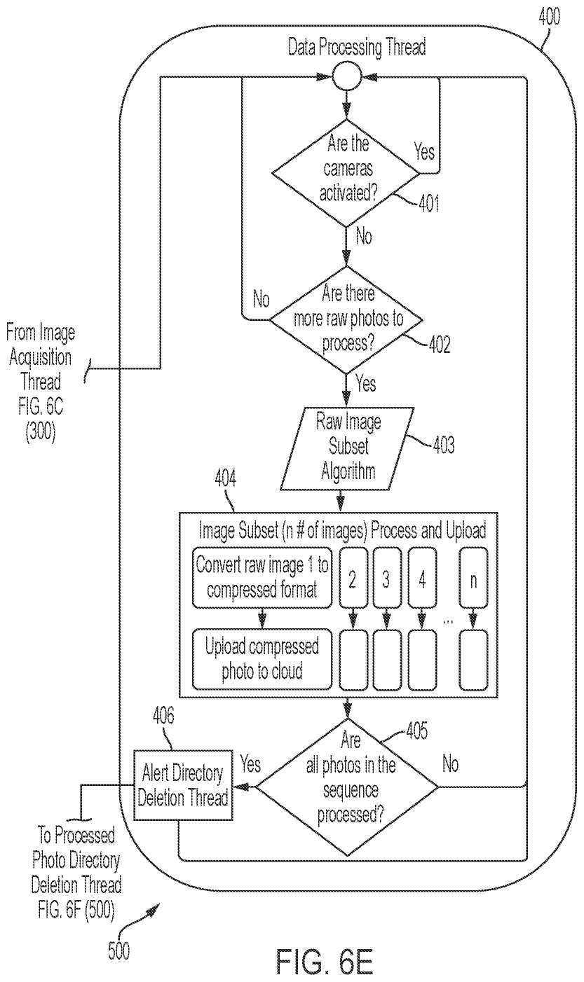

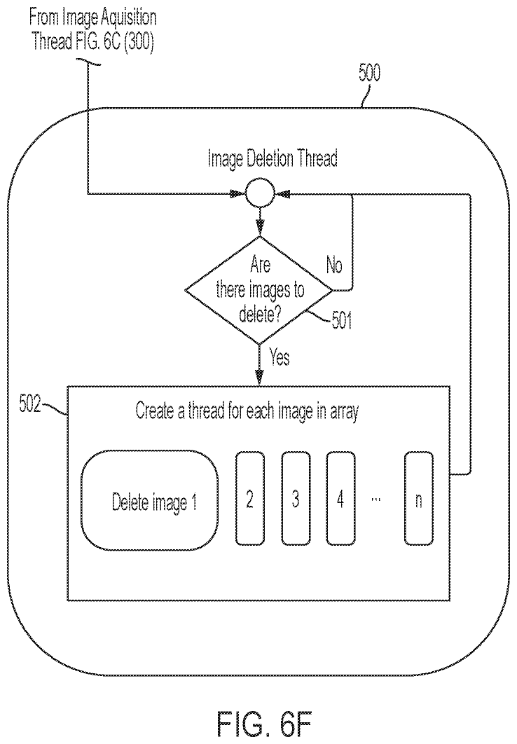

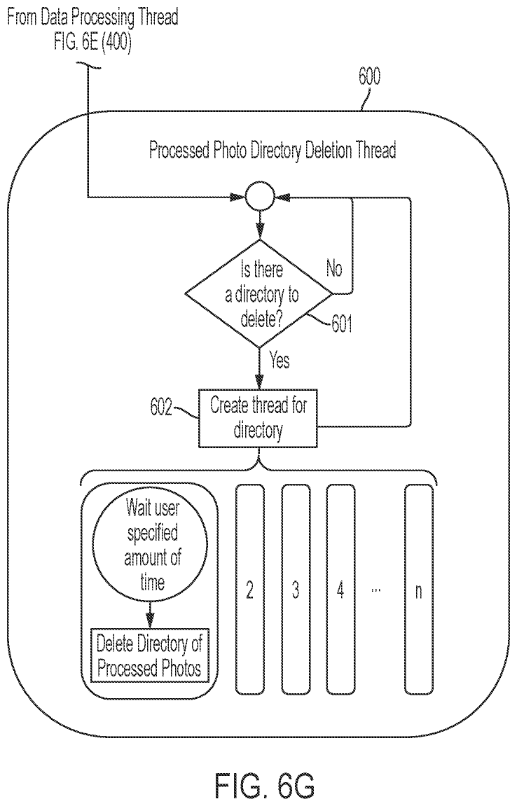

With reference to FIGS. 5, and 6A-6G, provided is a Higher Level Description of an embodiment of a refrigerator with a live inventory method and system. These figures, and the descriptions that follow, provide a thread executed process to provide Cloud Based Live Inventory associated with a Refrigerator. The threads and processes described provide an example of a Live Inventory and Internal Environmental Sensing System for an object storage structure, such as a Refrigerator.

FIG. 5 is a high-level thread processes flow chart of a Refrigerator Live Inventory System according to an embodiment of this disclosure, the Refrigerator Live Inventory System including an Initial System process to set variables, create threads, prepare environments 100, a Camera Trigger Thread to check sensors and update variables 200, an Image Acquisition Thread when triggered, captures images and send them to other threads 300, a Data Processing Thread to process raw images and upload compressed photos 400, an Image Deletion Thread to delete all images in a sequence where object did not enter shelf 500, a Processed Photo Directory Deletion Thread to wait a specified amount of time, then delete the processed photo directory 600. The specified amount of time can be a user specified amount of time or a specified amount of time programmed into the system by an administrator.

The user, developer, or system administrator launches the script indicating whether to run locally or with uploading to the cloud. Additionally, they can designate if they wish the uploaded photos to be deleted on the local drive, and the amount of time those photos will stay on the drive before deletion. The system initializes; setting initial states for variables, preparing the environments, and creating the helper threads that performs tasks throughout the system.

The Camera Trigger Thread checks the object proximity sensor(s) and shelf entry plane sensor(s) and updates the variables that give the rest of the system the following information: object direction, shelf number, whether to process and upload the raw images, and if there is an object nearby.

When an object is near, the Image Acquisition Thread triggers the cameras to capture images. As soon as the object is no longer near, as based on the logic from the Camera Trigger Thread, the Image Acquisition Thread stops capturing images and returns to its normal waiting state. If the user pauses the system, this thread pauses and will no longer capture images. Since no new images can be captured, this effectively pauses the rest of the system, without interrupting/breaking any processing steps downstream.

If the object entered a shelf, based on the variable from the Camera Trigger Thread, the images captured by the Image Acquisition Thread are given to the Data Processing Thread which processes and uploads the compressed photos a couple at a time. Whenever the cameras are capturing images, this thread pauses to allow the processing resources of the computer to be allocated to the camera capture. If post upload deletion was designated at launch, the name of the directory containing the processed photos after upload is sent to the Processed Photo Directory Deletion Thread.

The Processed Photo Directory Deletion Thread creates a new thread for every incoming sequence, which pauses for the launch designated amount of time before deleting the directory given by the Data Processing Thread. Each new sequence gets its own thread, allowing the wait times to be independent of one another for consistency and speed in the system.

If the object did not enter a shelf after image capture in the Image Acquisition Thread, the raw images are instead sent to the Image Deletion Thread where each image is deleted in parallel in its own thread. Once all the raw images given to it are deleted, the Image Deletion Thread loops back and waits for more inputs. Each of these five threads continue indefinitely until the user, developer, or system administrator pauses and shuts down the system.

FIGS. 6A-6G include detailed processes flow charts of a Refrigerator Live Inventory System as shown in FIG. 5 according to an embodiment of this disclosure, the figures providing further process details executed by the System Initialization process 100 (FIG. 6B), the Image Acquisition Thread 300 FIG. (FIG. 6C); the Camera Trigger Thread 200 (FIG. 6D); the Data Processing Thread 400 (FIG. 6E); the Image Deletion Thread 500 (FIG. 6F), and the Processed Photo Directory Deletion Thread 600 (FIG. 6G).

System Initialization 100 including: Procure User ID; Set Environment (Production vs Staging); Data Lake Integration Init (S3); Process Flags -n(upload), -s (staging), -d (deleted processed files after upload); Create Helper Threads, *Camera Trigger, *Image Acquisition, *Data Processing, *Image Deletion, *Directory Deletion; Enable Lighting; Camera Configuration (Gain, Exposure, Pixelformat, ReverseX, ReverseY); Establish ML Image Data (Width, Height, Confidence).

The Image Acquisition Thread 300 when triggered, capture images and send them to other threads 400/500/600. This thread includes the following processes/subprocesses:
Initially, a Signal from Camera Trigger Thread 301 is received indicating there are images to be processed;
Next, the Image Acquisition Thread performs a Create directory 302 process;
Then, a Capture Images 303 process is performed and a Prep S3 304 is performed;
Then this thread determines Did an object go into shelf? 305; IF YES, Alert Data Processing Thread 307, IF NO Alert Image Deletion Thread 306.
The Alert Image Deletion Thread 306 receives the images from the Camera Trigger Thread 200 and initiates deletion of images only after receiving instructions to do so from the Did an object go into shelf? 305 process. The Image Deletion Thread 500 is described further below.

The Camera Trigger Thread performs the following processes:
Initially this thread performs a process to Read Sensors 201 including 1) Object Detection Thread: Is an object near?; and 2) Object in Shelf? Which Shelf?;
Then, this thread proceeds t perform an Image Deletion Determination Algorithm 202; a Shelf ID Algorithm 203; a Direction Algorithm 204; and an Object Near but not in shelf 205. Data from the Camera Trigger Thread 200 communicated to the Image Acquisition Thread 300 includes Process and Upload Y/N, Shelf Number, Object Direction, Affirmative determination that Object is Near but not in Shelf.

The Data Processing Thread 400 performs the following processes:
Initially this thread is initialized by being alerted by the Image Acquisition Thread 300 that images are available for processing;
Then, the Data Processing Thread 400 determines Are the cameras activated? 401, IF NO, THEN
Are there more raw photos to process? 402, IF YES, THEN
Perform a Raw Image Subset Algorithm 403 and the Image Subset (n # of images) is Processed and Uploaded 404;
Next, the Data Processing Thread 400 determines Are all photos in the sequence processed? 405; IF YES, perform a process to Alert Directory Deletion Thread 406, IF NO RETURN to beginning of thread.

The Image Deletion Thread performs a processes to delete all images in a sequence where object did not enter shelf 500, this process including:
Initially determining Are their images to delete 501; IF YES, THEN Create a thread for each image in array 502.

The Processed Photo Directory Deletion Thread performs the following processes for deleting the processed photo directory 600, the process including:
Initially performing a process to determine if there is a directory to delete 601, IF YES, THEN Create thread for directory 602;
Then perform a process to Wait a user specified amount of time, THEN Delete Directory of Processed Photos. Alternatively, the Wait period can be predetermined by an administrator of the system.

Provided below is a further Mid-Level Description of the Refrigerator Live Inventory System as shown in FIG. 5 and FIGS. 6A-6G.

Launching the Script:
User navigates to script location and runs the following command with various flags as defined below:
To run script locally (script doesn't upload images to the cloud): ′python app.py′
To run script with upload to production: ′python app.py -n′
To run script and delete the processed photo directory after uploading it to the cloud: ′python app.py -d x′ where ′x′ defines the number of seconds the script should wait before deleting the directory.

System Initialization (FIG. 6B)

When the script initializes, it first processes the arguments parsed in from the launch in the terminal. The user can add ′-s′/′--s′, ′-n′/′--n′, or ′-d x′/′ --delete x′ (where x denotes a user chosen number) as a flag after the required ′python app.py′. It then prompts the user for a “user id” that will be used to categorize the sequences on both the refrigerator front end and on the back end.

According to an embodiment, the hardware configuration includes two NVIDIA AGX Xavier Jetsons, one that controls the lights, camera clocks, and top three cameras and two sets of light curtains, and another that controls the bottom three cameras and two sets of light curtains. The script checks which computer it is running on, top or bottom, and sets up the camera clocks and light level accordingly.

The system then creates five threads that will run in parallel with the main Image Acquisition Thread: a Camera Trigger thread, a Data Processing Thread, a Processed Photo Directory Deletion thread and an Image Deletion Thread. Finally, the system configures the cameras, sets up the environment for sending photos to the production or staging server, and moves into the Image Acquisition Thread.

Image Acquisition Thread (FIG. 6C)

This thread constantly loops waiting for a signal from the Camera Trigger Thread 200. Once it receives this signal, it begins an uninterruptable sequence that starts with creating a directory for the saved images and continues with triggering the cameras to capture images. The cameras will continue to capture images while the signal from the Camera Trigger Thread is high and stop when it goes low. Once it completes, S3 is notified of the incoming images and the user is alerted.

The thread will then check the process_and_upload variables from the Camera Trigger Thread. If the images should be kept, i.e., the process_and_upload variable is True, the location of the raw images from the camera are given to the Data Processing Thread 400 for processing and potential uploading. Otherwise, the location of the images is sent to the Image Deletion Thread 500 for deletion. As soon as this is complete, the loop resumes and waits for another signal from the Camera Trigger Thread.

If at any point, while this thread is waiting for another camera trigger signal, the user interrupts the system, this thread will pause. This effectively pauses the entire system because no new images will be captured and sent on to the various processing threads. Those processing threads can continue to operate, and the sensor triggers will still update their variables, but the system will not respond to those inputs until the pause is removed. This is useful for maintenance of the refrigerator front end during operation and other administrative tasks.

The distinct advantage of this setup is that the team can run two sets of cameras simultaneously on separate machines. If the object going into the refrigerator front end does not pass the entry barrier, i.e., does not enter a shelf, the images are discarded. This means the system will ignore any images that are not a part of the sequence despite the depth camera triggering, such as the user's legs while they put an item in the top shelf.

Camera Trigger Thread (FIG. 6D)

Once this thread is created, it continuously checks the Camera Trigger Thread 200/Object Detection Thread 201 to see if an object is near and checks the status of the shelf entry sensors This information is then processed by the Image Deletion Determination Algorithm 202, the Shelf ID Algorithm 203, and the Object Direction Algorithm 204 to update the process_and_upload, Shelf Number, and Object Direction variables respectively. The process_and_upload variable determines whether the raw images captured in the Image Acquisition Thread 300 are either sent on for further processing or deleted. The Shelf Number and Object Direction variables provide critical information on the location and direction of the object that are sent to the back end for identification and further processing.

After the above algorithms finish, the thread determines if there is an object near and if that object is in a shelf. If there is an object near, and if the object has not already broken the entry plane of the shelf, the thread triggers the Image Acquisition Thread to begin capturing images by setting the trigger_cameras variable to True, otherwise it sets it to False. The thread then loops back to the start, reading the sensors once again. This gives real time updates to the variables that indicate whether an object is near or not and is not affected by the other threads.

Data Processing Thread (FIG. 6E)

At the start of the Data Processing Thread's loop 400, it checks to see if the cameras are currently capturing images (by checking the same variable, trigger_cameras, that the Image Acquisition Thread 300 checks to capture/not capture images). If the cameras are not capturing, it checks if there are more raw photos to process. If there are none, this loop repeats.

If the process_and_upload variable from the Camera Trigger Thread 200 is True, the Image Acquisition Thread 300 sends the location of the raw images to the Data Processing Thread 400. This means that when the Data Processing Thread 400 reaches the check for raw photos, there are photos to process, and it continues instead of looping back.

The raw images are broken into a subset defined by the developer based on the Raw Image Subset Algorithm 403. Each image in this new subset is given its own thread, where they are compressed and uploaded to the cloud in parallel to one another 404. Once that subset is complete, the thread checks if there are more and loops 405.

Once there are no more raw images to process in a sequence, and if the user selected the processed photo deletion flag on launch, the thread passes the location of the processed photos to the Directory Deletion Thread 406. Otherwise, they stay on the machine for developer insight and research.

The image subsetting and camera activation check are critical to the speed of the system. Only a handful of images are processed at a time, so the system can respond more quickly to an object entering the refrigerator because all the processing resources are not preoccupied by the compression and uploading. This thread will continue processing and uploading images until it runs out, unless the cameras are triggered, at which point it frees up the CPU cores to focus on image acquisition.

Image Deletion Thread (FIG. 6F)

Upon creation, this thread continually loops checking for images to delete 501. If the location of raw images is sent from the Image Acquisition Thread 300, as when there is an object near but doesn't enter the shelf, this thread creates subthreads for each image in the sequence 502. Each of these threads deletes the image and terminates. The maximum number of these threads can be tuned by the developer to affect system speed.

Processed Photo Directory Deletion Thread (FIG. 6G)

Upon creation, this thread continually loops checking for directories to delete 601. Once there is a directory to delete from the Data Processing Thread 400, this thread creates a subthread for that directory 602. This subthread waits a specified amount of time (specified at the launch of the script) and then deletes the directory that contains the processed photos. Each incoming directory gets its own subthread, so the wait time does not compound upon itself; each thread waits the same amount of time regardless of how many threads there are. When the directory is deleted, the subthread terminates.

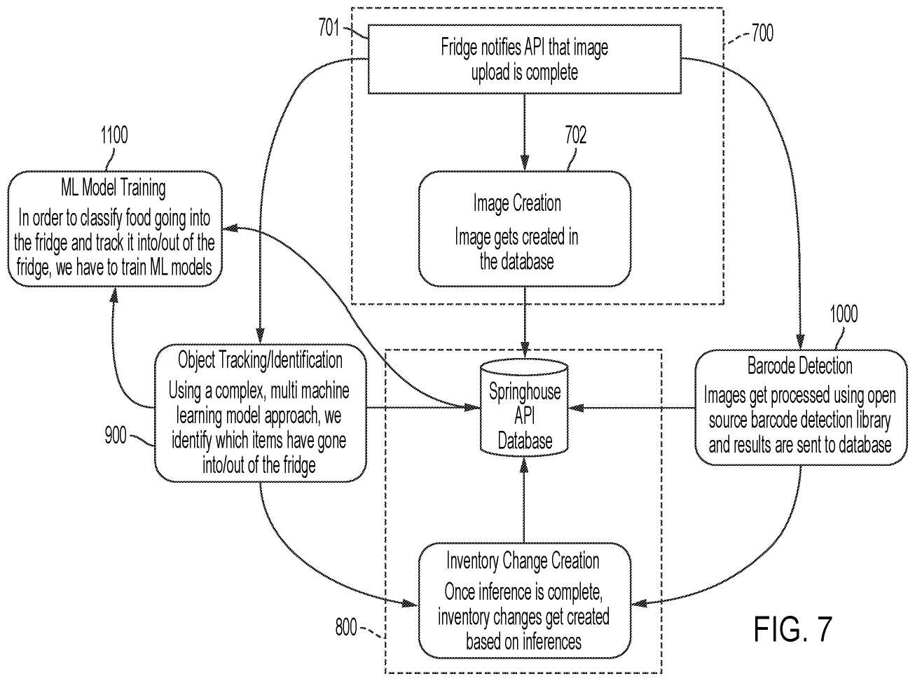

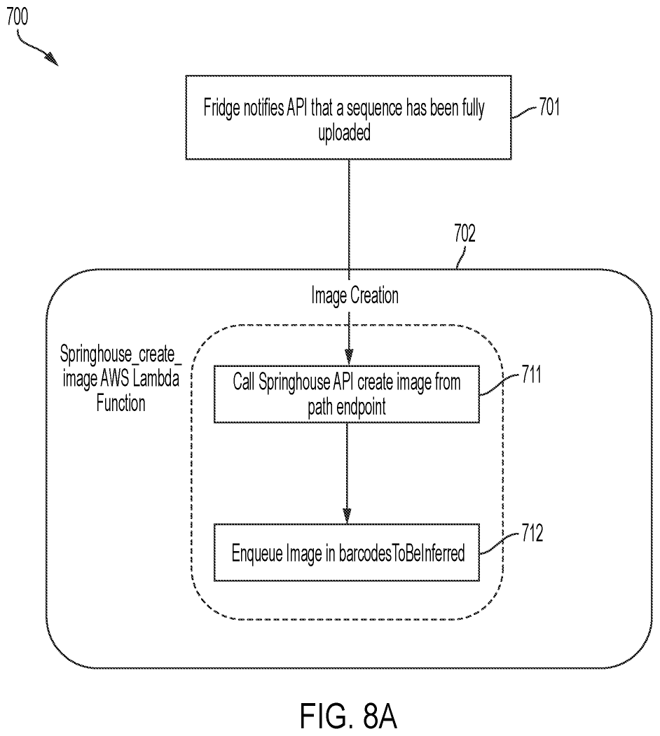

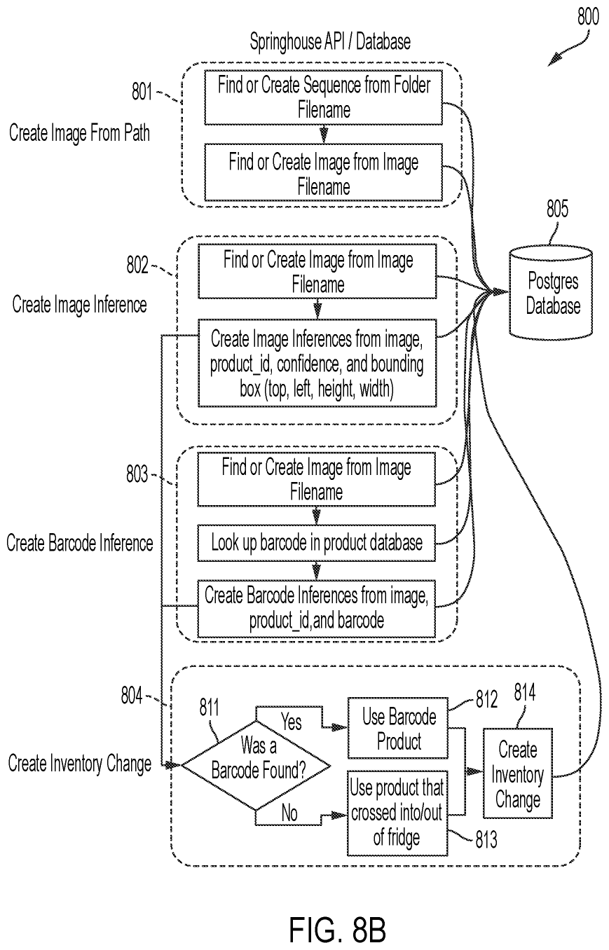

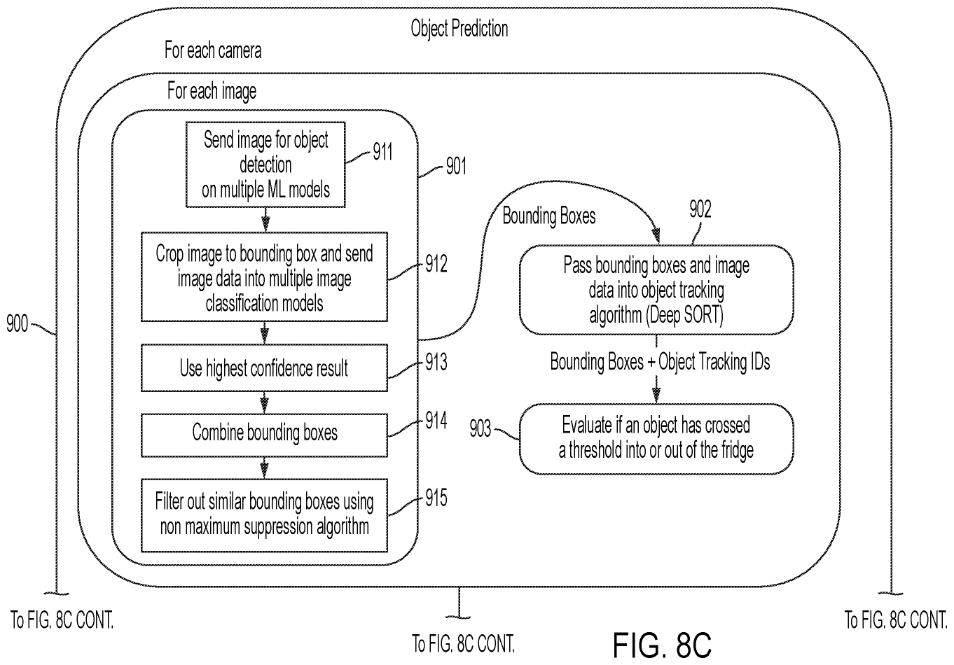

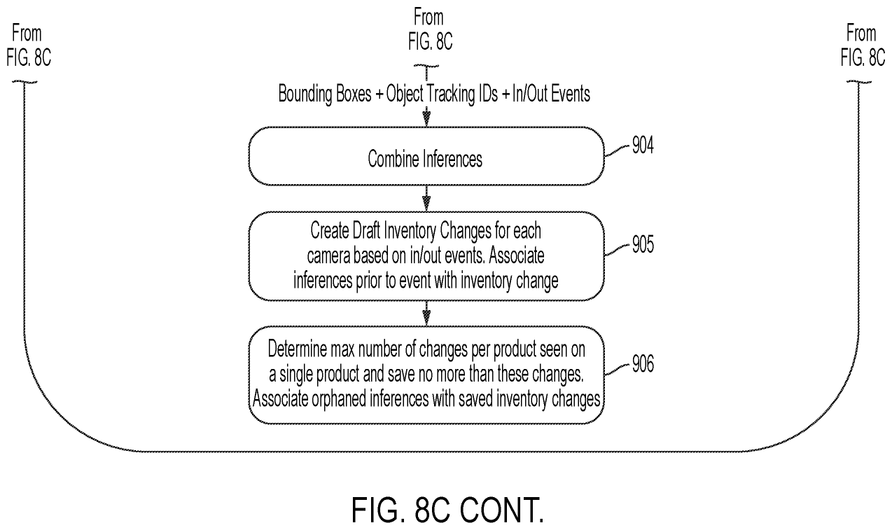

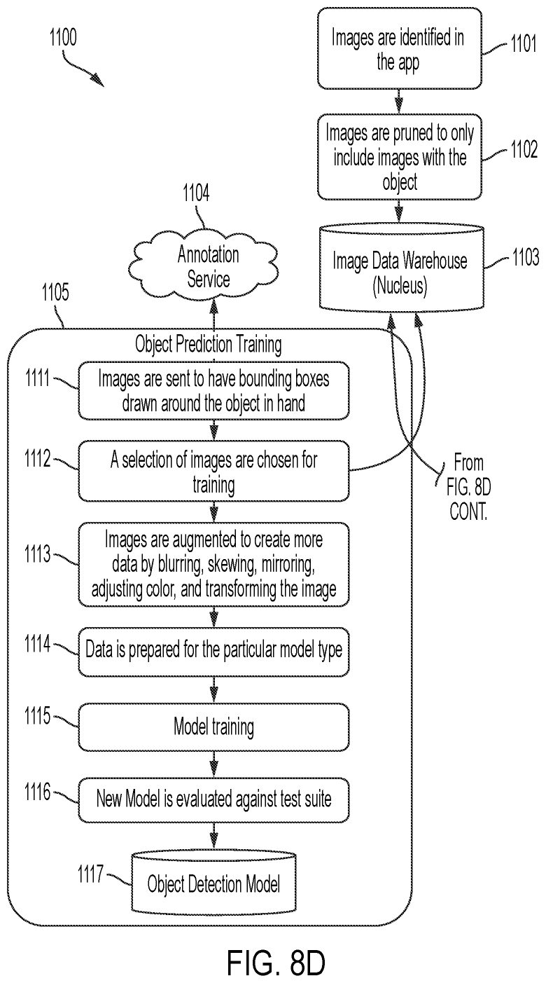

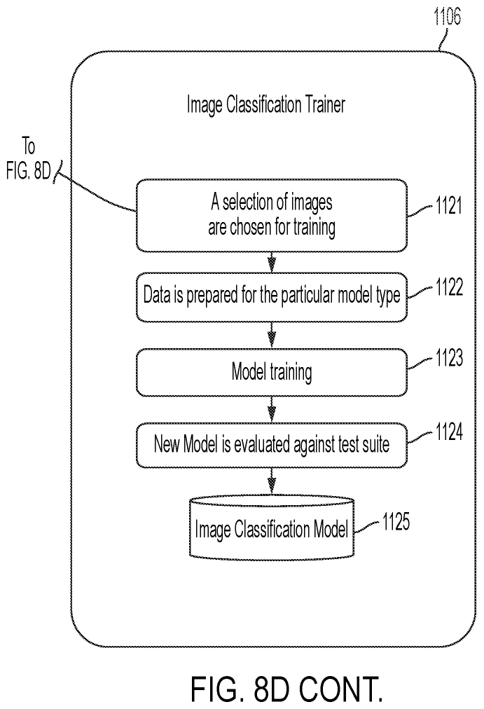

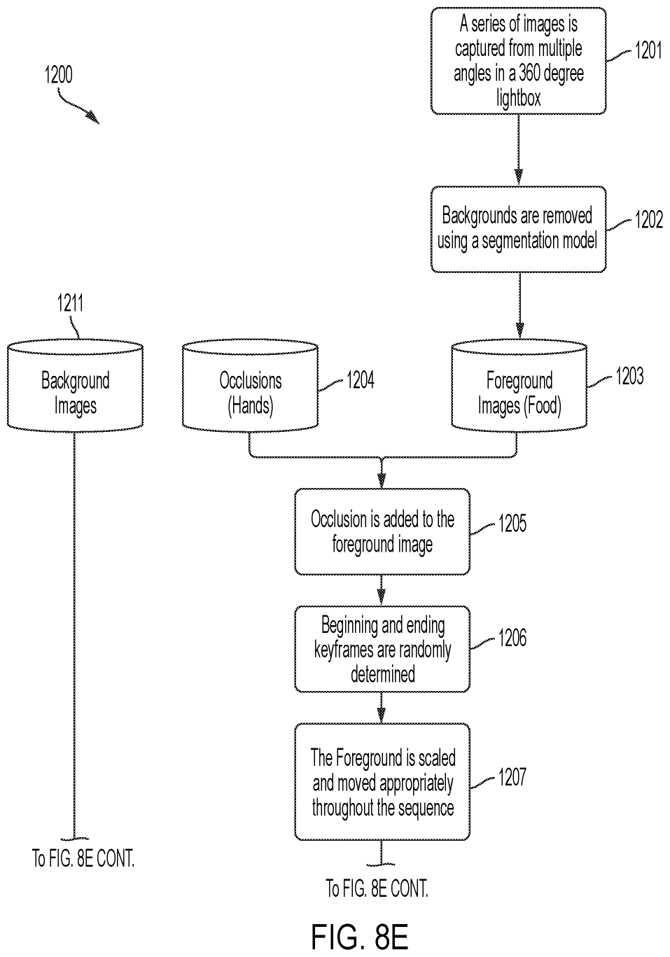

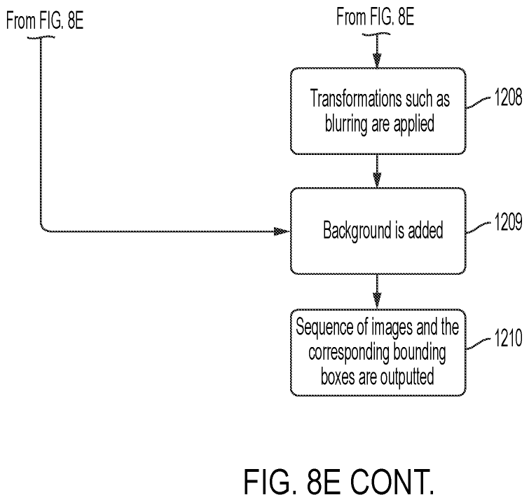

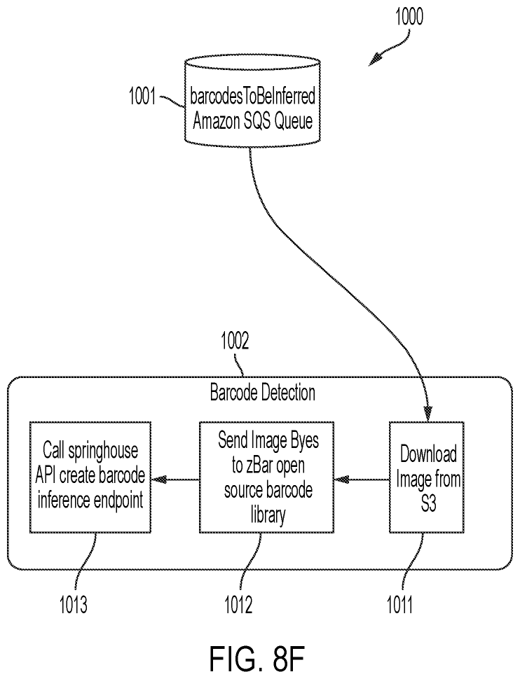

With reference to FIG. 7 and FIGS. 8A-8F, shown is another overall process flow chart of cloud-based image processing operations performed for a Refrigerator Live Inventory System according to an embodiment of this disclosure.

FIG. 7 is an overall processes flow chart of cloud-based image processing operations performed for a Refrigerator Live Inventory System according to an embodiment of this disclosure, the cloud-based image processing operations including a Refrigerator notifying the API that image upload is complete 701, a process for Image Creation-Image gets created in the database 702, communication with a Springhouse API/Database 800, a process for Object Tracking/Identification 900, a process for Barcode Detection 1000, and a process for ML Model Training 1100.

Once the refrigerator has finished uploading images to Amazon S3, it sends a callback to the API server to indicate that the upload is complete. 700/701/702 The API then triggers the Airflow inference pipeline which goal is to process the images resulting in a change to the inventory of what's in the refrigerator. 700

The inference pipeline begins by processing each camera's images separately. These images are downloaded and the image data is sent to one or more object detection models. These models can be different ML model architectures (YOLO vs FRCNN vs GapCNN vs other models) or they can be different models of the same architecture. The results of these models may be used as described herein or, alternatively, the process can zoom into all the regions of interest and pass the cropped image into another object detection model or an image classification model. This approach allows the use of more of the data of the object of interest to “zoom” into details such as the writing on a product label.

From here, the results of each model are combined and all the bounding boxes are passed into a non max suppression algorithm to merge duplicate bounding boxes. This is especially important when using multiple object detection algorithms since multiple algorithms often find the same objects of interest.

After eliminating duplicate bounding boxes, the results are sent into an object tracking algorithm (for example, Deep SORT). Its goal is to correlate bounding boxes across multiple frames of a video. The result is that each bounding box receives an object tracking ID, ensuring the apple in frame 1 is the same as the apple in frame 100.

Finally, the process iterates over each frame determining whether an object has crossed into or out of the refrigerator. Previous predictions are used for the object's class and these are combined to come up with a food prediction and confidence that is used to change the inventory of the refrigerator. This concludes the part that gets run across each camera.

FIGS. 8A-8F are more detailed flow charts of is the cloud-based image processing operations, shown in FIG. 7, performed for a Refrigerator Live Inventory System according to an embodiment of this disclosure, the figures providing further process details for a Refrigerator notifying the API that image upload is complete 701 (FIG. 8A), a process for Image Creation-Image gets created in the database 702 (FIG. 8A), communication with a Springhouse API/Database 800 (FIG. 8A), a process for Object Tracking/Identification 900 (FIG. 8C), a process for Barcode Detection 1000 (FIG. 8F), and a process for ML Model Training 1100 (FIG. 8D). In addition, a Synthetic Data process 1200 to synthetically generate images for Object Detection/Prediction Training is shown.

Springhouse Model Training Overview

Springhouse products, i.e., the exemplary Live Inventory System/Process disclosed herein, employ the use of machine learning models as a part of the inventory management system. An essential part of the creation of any machine learning based model is the process in which it is trained. These models are trained to provide essential information that is used to localize and identify (classify) objects as they move in or out of the unit. The inventory management process primarily uses computer vision models, trained on image data and other related descriptive information. After a model is trained, it can be used to predict likely locations and classifications from video or single images.

Training Data Collection

In order to train the required models, one must collect or obtain sufficient training data. For this system, images of items are collected from video of items moving in and out of a refrigerator rig or from synthetically generated images; both of these processes are described elsewhere. Other information is also collected, such as product classification data (product name, brand, etc.), category information, and anything else useful for generating a prediction. This descriptive information is referred to as “labels”, as they represent a reliable ground truth that corresponds with each image. Images that are not useful for training are pruned out of the dataset. The training data (images and labels) are stored in such a way that the training process can map images to labels.

Model Types

Object localization and classification tasks can be performed by various model types; most commonly neural networks are used today. For computer vision tasks, the following techniques are used:
One-stage model: Both object localization and classification are performed with a single model.
Two-stage models: Aa initial model localizes potential “regions of interest” (ROI) but does not classify those items. A second model then used the ROIs to classify each region. Unlikely ROIs are then removed from final results.
For training purposes, both one and two stage models can use the same images and labels.

Object Detection

In object detection, the desired output is a set of coordinates, within an image, that contain an object of interest. The training label generally contains a ground truth value of those coordinates.

Object Classification

The goal of any machine learning training process is to “learn from data”, such that inferences can be made later with previously unseen data. More variety in the training data, generally produces more robust models. As part of the training process, the original source images can be modifies in various ways to produce more variation in the training data. These variations may include change in brightness, contrast, blur, image translations, and artificial partial obstructions. The training process is iterative, looping over training data examples in a loop. Typically, the model is evaluated with the training loop periodically, against a separate validation data set. From this validation set, metrics on model performance can be produced. Trained models can be saved and used later for inference.

Further details of the threads/processes are described below:

701/702 subprocesses associated with 700 (Image Creation) include the following:
Initially, Refrigerator notifies API that image sequence upload is complete 701;
Next, this process performs Image Creation 702 including: Call Springhouse API create image from path endpoint 711 and Enqueue Image in barcodes to be inferred 712.

The Springhouse API/Database 800 includes the following processes:
Create Image From Path 801;
Create Image Inference 802;
Create Barcode Inference 803;
Create Inventory Change 804;
Postgres Database 805;
Was Barcode Found? 811;
Use Barcode Product 812;
Use product that crossed into/out of refrigerator 813; and
Create Inventory Change 814.

Object Prediction processes include the following:
For each image create bounding boxes 901;
Pass bounding boxes and image data into object racking algorithm (Deep SORT) 902;
Evaluate if an object has crossed a threshold into or out of the refrigerator 903;
Combine Inferences 904;
Create Draft Inventory Changes for each camera based on in/out events. Associate inferences prior to event with inventory change 905;
Determine max number of changes per product seen on a single product and save no more than these changes. Associate orphaned inferences with saved inventory changes 906;
Send image for object detection on multiple ML models 911;
Crop image to bounding box and send image data into multiple image classification models 912;
Use highest confidence result 913;
Combine bounding boxes 914;
Filter out similar bounding boxes using non maximum suppression algorithm 915.

The ML Model Training 1100 processes include the following:
Images are identified in the app 1101;
Images are pruned to only include images with the object 1102;
Image Data Warehouse 1103;
Annotation Service 1104;
Object Prediction Training 1105;
Image Classification Trainer 1106;
Image are sent to have bounding boxes drawn around the object in hand 1111;
A selection of images are chosen for training 1112;
Images are augmented to create more data by blurring, skewing, mirroring, adjusting color, and transforming the image 1113;
Data is prepared for the particular model type 1114;
Model Training 1115;
New Model is evaluated against test suite 1116;
Object Detection Model 1117;
A selection of images is chosen for training 1121;
Data is prepared for the particular model type 1122;
Model Training 1123;
New Model is evaluated against test suite 1124; and
Image Classification Model 1125.

The Barcode Detection 1000 processes include the following:
Barcodes To Be Inferred Amazon SQS Queue 1001;
Barcode Detection 1002;
Download Images from S3 1011;
Send Image Byes to zBar open source barcode library 1012;
Call Springhouse API create barcode inference endpoint 1013.

The Synthetic Data 1200 processes include the following:
A series of images is captured from multiple angles in a 360 degree lightbox 1201;
Backgrounds are removed using a segmentation model 1202;
Foreground Images (Food)1203;
Occlusions (Hands) 1204;
Occlusion is added to the foreground image 1205;
Beginning and ending keyframes are randomly determined 1206;
The Foreground is scaled and moved appropriately throughout the sequence 1207;
Transformations such as blurring are applied 1208;
Background is added 1209;
Sequence of images and the corresponding bounding boxes are outputted 1210; and
Background images 1211.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

What is claimed is:

1. A method for dynamically identifying an object being placed in or taken out of a refrigerator, the method comprising:
detecting a motion of an object at the refrigerator using one or more sensors coupled with the refrigerator or sensing the refrigerator is open;
acquiring one or more images of at least a part of the object as the object is being placed inside the refrigerator or removed from the refrigerator; and
using the acquired images, tracking the motion of the object, determining a direction of the motion of the object, and identifying the object using a trained ML (Machine Learning) model, the ML model trained, at least in part, using a crowd-based training method including acquisition of images from other refrigerators.

2. The method for dynamically identifying an object being placed in or taken out of a refrigerator according to claim 1, further comprising:
based on the direction determination, determining whether the object is being added to or removed from the refrigerator.

3. The method for dynamically identifying an object being placed in or taken out of a refrigerator according to claim 1, further comprising:
updating a live inventory record associated with the objects within the refrigerator based on the identified object and the determined direction.

4. The method for dynamically identifying an object being placed in or taken out of a refrigerator according to claim 4, further comprising:
on a smart device, displaying information based on the live inventory record.

5. The method for dynamically identifying an object being placed in or taken out of a refrigerator according to claim 1, comprising:
detecting a hand moving through an entrance area of the refrigerator;
determining whether the hand is carrying the object;
determining what direction the hand is moving; and
based on the hand direction determination and the determination as to whether the hand is carrying the object, updating the live inventory record for the refrigerator.

6. The method for dynamically identifying an object being placed in or taken out of a refrigerator according to claim 1, comprising:
detecting a presence of the object within scanning range of a scanner coupled with the refrigerator;
scanning the object using the scanner;
obtaining scanning data from the scanner indicating a characteristic of the object; and
storing characteristic information about the object based on the scanning data.

7. The method for dynamically identifying an object being placed in or taken out of a refrigerator according to claim 6, wherein the scanner is a near infrared (NIR) scanner.

8. The method for dynamically identifying an object being placed in or taken out of a refrigerator according to claim 1, wherein there are two trained ML models, a first model used for tracking objects and a second model used for and identifying objects.

9. The method for dynamically identifying an object being placed in or taken out of a refrigerator according to claim 8, wherein the tracking model resides on local hardware operatively associated with the refrigerator and the identification model resides on a remote cloud based system, the tracking model sorting the sequence of images to determine if the object went in or out of the refrigerator, and then the local hardware sending one or more of the sequence of images to the second model to identify the object.

10. The method for dynamically identifying an object being placed in or taken out of a refrigerator according to claim 9, further comprising:
as a user moves towards the refrigerator, depth cameras triggering rgb cameras to begin capturing the sequence of images, and in parallel, a thread is opened for processing to determine if an object is in hand within the sequence of images, and If the object is going in or out of the refrigerator, the local hardware sends one or more of the sequence of images to the remote cloud based system for identification of the object, and
once identified, updating a live inventory record associated with the objects within the refrigerator.

11. A computer readable storage medium including executable computer code embodied in a tangible form wherein the computer readable medium comprises:
executable computer code operable to detect a motion of an object being placed in or taken out of a refrigerator using one or more sensors coupled with the refrigerator;
executable computer code operable to acquire one or more images of at least a part of the object;
executable computer code operable to determine a direction of the motion of the object; and
executable computer code operable to identify the object based on the one or more images, wherein the computer code uses the acquired images to track the motion of the object, determine a direction of the motion of the object, and identify the object using a trained ML (Machine Learning) model, the ML model trained, at least in part, using a crowd-based training method including acquisition of images from other refrigerators.

12. The computer readable storage medium of claim 11, further comprising:
executable computer code operable to determine whether the object is being added to or removed from the refrigerator based on the direction determination.

13. The computer readable storage medium of claim 11, further comprising:
executable computer code operable to update live inventory records data for the refrigerator based on the identified object and the determined direction.

14. The computer readable storage medium of claim 13, further comprising:
executable computer code operable to detect a hand moving through an entrance area of the refrigerator;
executable computer code operable to determine whether the hand is carrying the object;
executable computer code operable to determine what direction the hand is moving; and
executable computer code operable to update inventory records data for the refrigerator based on the hand direction determination and the determination as to whether the hand is carrying the object.

15. The computer readable storage medium of claim 11, wherein there are two trained ML models, a first model used for tracking objects and a second model used for and identifying objects.

16. The computer readable storage medium of claim 15, wherein the tracking model resides on local hardware operatively associated with the refrigerator and the identification model resides on a remote cloud based system, the tracking model sorting the sequence of images to determine if the object went in or out of the refrigerator, and then the local hardware sending one or more of the sequence of images to the second model to identify the object.

17. The computer readable storage medium of claim 16, further comprising:
as a user moves towards the refrigerator, depth cameras triggering rgb cameras to begin capturing the sequence of images, and in parallel, a thread is opened for processing to determine if an object is in hand within the sequence of images, and If the object is going in or out of the refrigerator, the local hardware sends one or more of the sequence of images to the remote cloud based system for identification of the object, and
once identified, updating a live inventory record associated with the objects within the refrigerator.

18. A live inventory system for dynamically identifying an object being placed in or taken out of a refrigerator, the system comprising:
a refrigerator;
one or more cameras operatively associated with the refrigerator;
one or more sensors operatively associated with the refrigerator;
at least one processor operatively associated with the refrigerator; and
at least one memory circuitry operatively associated with the refrigerator, the at least one memory circuitry including a computer readable storage medium that includes computer code stored in a tangible form wherein the computer code, when executed by the at least one processor, causes the storage system to:
detecting a motion of an object at the refrigerator using one or more sensors coupled with the refrigerator or sensing the refrigerator is open;
acquiring one or more images of at least a part of the object as the object is being placed inside the refrigerator or removed from the refrigerator; and
using the acquired images, tracking the motion of the object, determining a direction of the motion of the object, and identifying the object using a trained ML (Machine Learning) model, the ML model trained, at least in part, using a crowd-based training method including acquisition of images from other refrigerators.

19. The live inventory system according to claim 18, further comprising:
based on the direction determination, determining whether the object is being added to or removed from the refrigerator.

20. The live inventory system according to claim 18, further comprising:
updating a live inventory record associated with the objects within the refrigerator based on the identified object and the determined direction.

21. The live inventory system according to claim 18, further comprising:
on a smart device, displaying information based on the live inventory record.

22. The live inventory system according to claim 18, comprising:
detecting a hand moving through an entrance area of the refrigerator;
determining whether the hand is carrying the object;
determining what direction the hand is moving; and
based on the hand direction determination and the determination as to whether the hand is carrying the object, updating the live inventory record for the refrigerator.

23. The live inventory system according to claim 18, comprising:
detecting a presence of the object within scanning range of a scanner coupled with the refrigerator;
scanning the object using the scanner;
obtaining scanning data from the scanner indicating a characteristic of the object; and
storing characteristic information about the object based on the scanning data.

24. The live inventory system according to claim 23, wherein the scanner is a near infrared (NIR) scanner.

25. The live inventory system according to claim 18, wherein there are two trained ML models, a first model used for tracking objects and a second model used for and identifying objects.

26. The live inventory system according to claim 25, wherein the tracking model resides on local hardware operatively associated with the refrigerator and the identification model resides on a remote cloud based system, the tracking model sorting the sequence of images to determine if the object went in or out of the refrigerator, and then the local hardware sending one or more of the sequence of images to the second model to identify the object.

27. The live inventory system according to claim 26, further comprising:
as a user moves towards the refrigerator, depth cameras triggering rgb cameras to begin capturing the sequence of images, and in parallel, a thread is opened for processing to determine if an object is in hand within the sequence of images, and If the object is going in or out of the refrigerator, the local hardware sends one or more of the sequence of images to the remote cloud based system for identification of the object, and
once identified, updating a live inventory record associated with the objects within the refrigerator.
